(19) United States
(12) Patent Application Publication
(10) Pub. No.: US 2026/0054598 A1
(43) Pub. Date: Feb. 26, 2026

(54) SYSTEMS, APPARATUS, AND METHODS FOR FLEET EMERGENCY CHARGING

(71) Applicant: Kitu Systems, Inc., San Diego, CA (US)

(72) Inventor: Richard Keith Kornfeld, San Diego, CA (US)

(73) Assignee: Kitu Systems, Inc., San Diego, CA (US)

(21) Appl. No.: 19/307,832

(22) Filed: Aug. 22, 2025

Related U.S. Application Data
(60) Provisional application No. 63/686,088, filed on Aug. 22, 2024.

(51) Int. Cl. B60L 53/68; B60L 53/10; B60L 53/62; B60L 53/67

(52) U.S. Cl. CPC B60L 53/68; B60L 53/11; B60L 53/62; B60L 53/67

(57) ABSTRACT

Systems, apparatus, and methods for emergency charging. Within the context of an EV fleet depot, the fleet vehicles are typically owned/controlled by a company or organization which has an interest in communal resource allocation. The communal resource management considerations of vehicle fleets create new opportunities for resource allocation which are not readily available to e.g., individual consumers. Various aspects of the present disclosure are directed to shared communication protocols within a fleet of vehicles that facilitate efficient resource allocation. Communication and evaluation may be formalized according to a shared rule set and metrics (promulgated by the fleet authority, etc.). Various aspects of the present disclosure may further extend the concepts of priority and/or severity to site-wide power management. Conceptually, power may be distributed to power a first priority, before distributing the remaining power to the next priority, etc. This isolates the first prioritization level from internal and/or external throttling.

### PRIORITY

This application claims the benefit of priority to U.S. Provisional Patent Application No. 63/686,088 entitled “SYSTEMS, APPARATUS, AND METHODS FOR FLEET EMERGENCY CHARGING” filed Aug. 22, 2024, incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of electric vehicle charging. More particularly, the present disclosure relates to systems, apparatus, and methods for fleet emergency charging.

### DESCRIPTION OF RELATED TECHNOLOGY

An electric vehicle (EV) fleet depot is a facility where electric vehicles used by a company or organization are housed, charged, maintained, and managed. These depots serve as centralized locations for operations involving a fleet of electric vehicles, which can include cars, vans, buses, or trucks.

L3 or DC chargers (also referred to as “fast chargers”) deliver power to charge the vehicle's battery much faster than L2 or AC chargers. For reference, L2 chargers can deliver up to about 20 kW. L3 chargers are commercially available for higher power delivery—in some cases, even above 1 MW. However, fast charging technology involves specialized hardware to safely manage the power delivery. Fast charging solutions may be unsuitable for widespread use in an EV fleet depot.

### BRIEF DESCRIPTION OF THE DRAWINGS

FIG. 1 logical block diagram of an electric vehicle (EV) fleet depot site, useful to explain various aspects of the present disclosure.

FIG. 2 is a logical block diagram for servicing emergency charging requests, useful to explain various aspects of the present disclosure.

FIG. 3 provides a logical system diagram of conventional Load Control Management System (LCMS) operation, useful to explain various aspects of the present disclosure.

FIG. 4 provides a logical system diagram of emergency-aware LCMS operation, useful to explain various aspects of the present disclosure.

FIG. 5 is a logical block diagram useful to explain non-emergency prioritization.

FIG. 6 is a logical block diagram of a distributed power management system.

FIG. 7 is a logical flow diagram of methods for fleet emergency charging.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Expropriation and Relinquishment for Emergency Charging

L2 chargers (and earlier L1 chargers) enable electric cars to charge using commonly available alternating current (AC) power outlets. The L2 charger and associated circuitry are managed in-vehicle. In contrast, L3 charging technology allows a charging site to provide direct current (DC) power to the vehicle-L3 chargers are external to the vehicle.

Emergency charging often refers to the process of providing an electric vehicle (EV) with a quicker charge than during normal operation; e.g., in situations where the vehicle's battery is critically low and there is an immediate need to recharge it. More precisely, however, emergency charging refers to charging that occurs when a vehicle's battery meets an emergency condition defined by the driver, administrator, or other authority. The condition could be, but may not be limited to, a state of charge (SOC) threshold, etc. Notably, the SOC threshold could be relatively high, for example, an emergency condition might set a 100% level for certain types of applications.

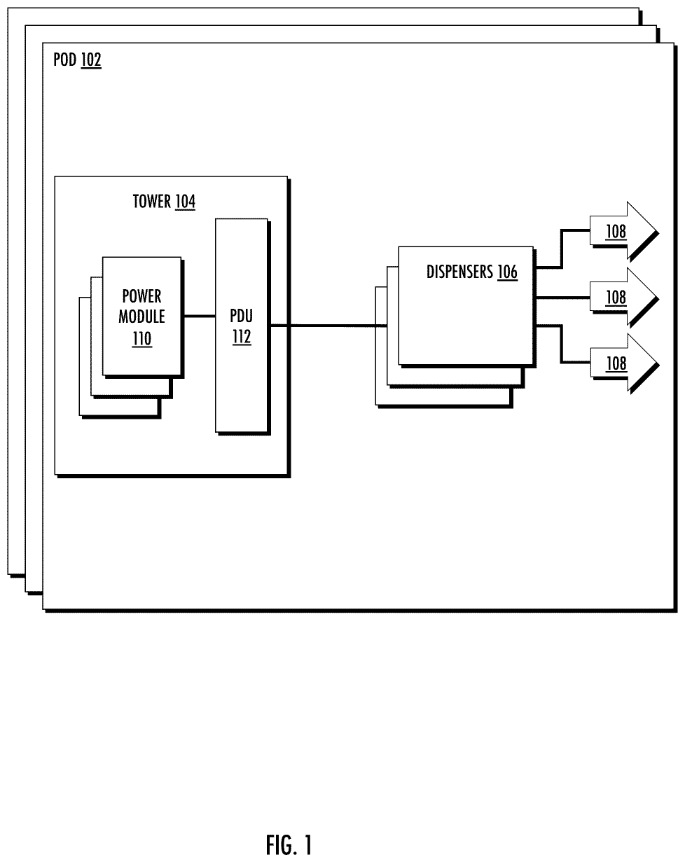

FIG. 1 is a logical block diagram of an electric vehicle (EV) fleet depot site, useful to explain various aspects of the present disclosure. As shown, the EV fleet depot site may have multiple pods 102. Each pod may include multiple towers 104, each of which include multiple dispensers 106, and multiple ports 108. Each pod may be configured to dispense power differently, and not all pods may support all the same functionality (e.g., emergency charging, etc.). The configuration depicted within FIG. 1 is purely illustrative, and other combinations and/or configurations may be substituted with equal success.

Functionally, a tower serves to physically house the power modules 110, control systems, user interface, and connectors needed to charge vehicles. In this example, the tower includes a single power distribution unit (PDU 112) that controls multiple power modules. The power modules are connected to dispensers; each dispenser may have one or more ports. Dispensers may include a user interface to enable the user to monitor and interact with the system; ports provide physical and electrical connection to the EV. The ports and dispensers may also implement additional power delivery safeguards.

A power distribution unit (PDU 112) distributes electrical power from the power modules to the charging ports attached to the dispensers. As shown in this example, a single PDU manages the dispensers and ports, however, the PDU may also be implemented with a hierarchical or distributed topology (not shown). In a hierarchical configuration, a multi-tower/pod assembly may have a primary PDU that controls a secondary PDUs within each tower. In a distributed configuration, a multi-tower/pod assembly may allow PDUs to coordinate functionality across towers. In fact, some portions of the PDU functionality may be logically implemented in the power module or in multiple PDU units, etc.

Consider an EV fleet depot with Nₛᵢₜₑ ports. Each port is rated for a maximum power (Pₘₐₓ); however, to save deployment costs, each power module delivers a substantially lower nominal power (Pₙₒₘ).

Notably, with so-called DC charging, the power module is located external to the electric vehicle, for example in the tower. This differs from so-called AC charging where the power module is located within the electric vehicle (and can be internally managed). DC charging requires careful coordination between the power source and the recipient. The power module coordinates with a corresponding power management logic of the vehicle to ensure that the delivered DC power is within safe and optimal parameters. However, a DC power module only controls its own output voltage and current. In other words, multiple EVs cannot effectively coordinate with a single power module—conflicts could result in dangerous scenarios e.g., two EVs could send conflicting instructions to the same power module.

Importantly, however, a single EV could control multiple power modules without issue. More directly, multiple power modules could be “stacked” to provide power to a single EV. During “emergency charging” operation, a tower may divert power modules from some ports, to bolster one or more other ports. In other words, the nominal power output from multiple power modules may be stacked up to (but not exceeding) the maximum power capability of a port (designated as an “emergency charging port” (ECP)). Emergency charging in this manner reduces the overall site power requirement from the grid and significantly reduces the cost of the charging equipment (a site that is required to deliver Pₘₐₓ to every port requires much more power and charging equipment).

As a brief aside, EV charging has inherited many of the assumptions of gasoline-fueled vehicles. Some gas stations may also provide specialized fuel, but these are provided via dedicated pumps that are specially marked (e.g., diesel is “green”, E85 is “yellow”, etc.)—and the delivery mechanisms are similar. Gasoline pumps provide “gas” at a volumetric rate; a vapor sensor determines when the pump needs to reduce its rate to prevent overfilling. While the gas station has a physical reservoir with limited capacity, customers do not know the current demands from other customers or the station's current reservoir levels. In fact, customers are purposefully kept “in the dark” regarding fuel availability; actual (and even perceived) shortages in gas often trigger undesirable behaviors (e.g., hoarding, etc.). While it is possible for customers to communicate between themselves, they each have limited information about their peers (e.g., trustworthiness, reliability, need, surplus, etc.), thus each customer only knows their own need and interests.

Within the context of an EV fleet depot, the fleet vehicles are typically owned/controlled by a company or organization which has an interest in communal resource allocation. Here, a “fleet” refers to a plurality of entities that are directed and/or controlled by a common authority (“fleet authority”). “Control” and its linguistic derivatives refers to logical and/or physical control over the way an action or task is performed; “direct” and its linguistic derivatives refer to logical and/or physical control over the result of the action or task. While the following examples are described in terms of a vehicle fleet, other types of fleets may be substituted with equal success (e.g., drones, robots, and/or other automata, etc.)

Conceptually, the communal resource management considerations of vehicle fleets create new opportunities for resource allocation which are not readily available to e.g., individual consumers. For example, a fleet authority may need to handle multiple emergency charging sessions per pod, multiple types of emergency severity, multiple vehicle types/users, etc. In other words, vehicle fleets need to efficiently manage their communal pool of resources. To these ends, various aspects of the present disclosure are directed to shared communication protocols within a fleet of vehicles that facilitate efficient resource allocation. Communication and evaluation may be formalized according to a shared rule set and metrics (promulgated by the fleet authority, etc.). As but one such example, a vehicle may use a numeric “severity” to represent its need; severity may be compared to the “priority” of active charging sessions of other vehicles to assess whether or not power modules should be “expropriated”.

As used herein, the term “expropriation” and its linguistic variants refers to the act of diverting resources assigned to a first entity, to a second entity, by direction/control of a shared authority entity (e.g., a fleet authority). Conceptually, the conventional “gas station” paradigm limits the fueling transaction to the customer and the gas station; the customer sees a price and decides whether or not they wish to purchase fuel based on their own information. In contrast, the exemplary embodiments described herein use a shared rule set for communicating need and surplus. The vehicles are coordinated by a fleet authority to work toward a common goal of efficient resource allocation for the fleet rather than their own individual interests.

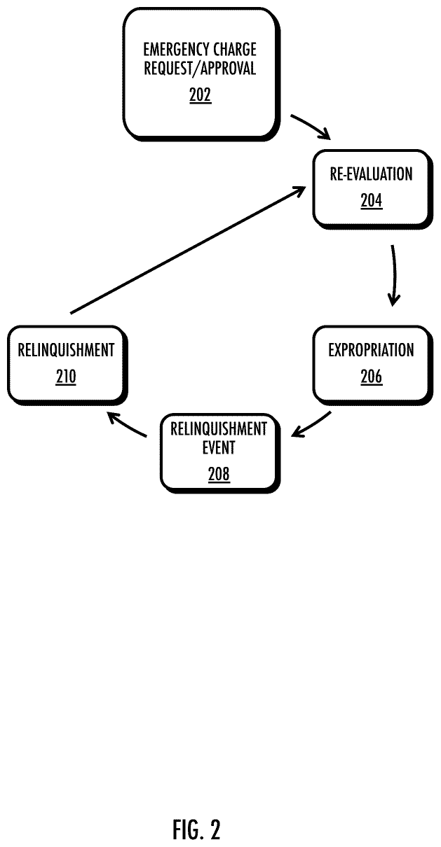

FIG. 2 is a logical block diagram for servicing emergency charging requests.

Initially, a driver requests emergency charging via a user interface of the dispenser (step 202). Alternative implementations may allow emergency requests via e.g. a mobile phone application, out-of-band message to a remote administrator, via a “swipe” from a designated fob or card, as issued by an administrator, etc. “Automatic” emergency charging requests may be substituted with equal success. For example, certain vehicles or users may automatically issue emergency charging requests. Similarly, specially marked emergency charging ports (ECPs) may always issue emergency charging requests. More generally any scheme for generating emergency charging requests may be substituted with equal success.

The emergency charging request is mapped to a numeric value representing the severity of the emergency. The severity mapping is defined in advance, according to the shared rule set promulgated by the fleet authority. One severity mapping is shown in Table 1 below:

TABLE 1
Exemplary Severity Scale

| Severity Value | Severity Description |
|---|---|
| 0 | Non-emergency |
| 7 | Standard Emergency |
| 10 | Critical Emergency |

Severity may be mapped according to any number of schemes. Simple schemes may use a binary severity (emergency, non-emergency). More complicated schemes may use multiple different severities—in some cases, severity may be further qualified and/or quantified by additional constraints.

In some cases, the pending emergency charging request may require approval via e.g., an on-site administrator or a call to a remote administrator or similar supervisory entity. Approval may entail authentication, authorization, accounting, etc. Emergency charging requests may also be logged and/or reported to other entities (e.g., managers, administrators, impacted drivers, etc.). In some cases, the pending emergency request may additionally be modified based on depot considerations and/or broader system constraints. For example, a depot may only allow a limited number of standard emergencies/critical emergencies. Excessive requests may be fine-tuned (e.g., +/−1, +/−2, etc.) and/or re-categorized if necessary (e.g., critical emergencies may be re-categorized as standard emergencies, etc.).

The severity of the request is compared to priority to assess whether the request should be serviced. Here, priority refers to the ability to initiate a charging session. Priority may be statically or dynamically assigned and may be based on the vehicle, the driver or the charging port, etc.

Once approved, the pod (or any shared authority entity, etc.) evaluates (and may also periodically re-evaluate, discussed below) emergency charging requests. The pod may consider multiple factors in assessing priority; e.g., vehicle type, vehicle condition, driver type, driver identity, port type, port operation, etc. Priority may be static, dynamic, and/or a hybrid (semi-static/dynamic). For example, plug-in hybrid vehicles which have fuel as a back-up may have a lower static priority than fully electric vehicles whereas emergency vehicles may have a higher priority than other vehicles. Similar assessments may be made based on driver type/identity (e.g., certain drivers may be statically prioritized over others) and/or port considerations (e.g., dedicated ECP ports may have a higher static priority relative to ECP-capable ports, etc.). Dynamic priority may increase/decrease priority based on time-varying conditions e.g., state of charge (SOC), pod-wide, and/or site-wide conditions, etc. For example, priority may be elevated when SOC is below a minimum threshold and/or reduced when SOC is above a maximum threshold. Similarly, fleet EVs are often left plugged-in until needed, even though their charging session is over—in these cases, the fully charged EV may be dynamically de-prioritized. As another example, certain emergency charging scenarios may have bursts of requests that arrive in short temporal succession (e.g., natural disasters, etc.)—these situations may require dynamic prioritization of certain vehicles over others.

One priority mapping is shown in Table 2 below:

TABLE 2
Exemplary Priority Scale

| Priority Value | Priority Description |
|---|---|
| 1 | Low - unused port |
| 2 | Low - PHEV |
| 3 | Low - Employee |
| 4 | Low - Designated Low Port, or Nominal + high SOC |
| 5 | Nominal - Default |
| 6 | High - Designated High Port, or Nominal + low SOC |
| 7 | High - Emergency Vehicle |
| | High - Standard severity emergency charging vehicle |
| 10 | High - Critical severity emergency charging vehicle |

Referring back to FIG. 2, the evaluation step calculates an “expropriation authority” based on the difference between severity and priority (step 204). Power modules are expropriated when severity is greater than priority (expropriation authority>0); shared when severity equals priority (expropriation authority=0); and left unchanged when severity is less than priority (expropriation authority<0). As a practical matter, unused power modules (empty ports and/or ports connected to fleet EVs that are fully charged) are preferentially re-mapped; power modules that are currently in use may also be re-mapped but require the appropriate expropriation authority to do so.

During the expropriation step (step 206), power modules are re-mapped to ports based on the expropriation authority. Expropriated power modules may be stacked together to deliver higher charging rates to service the emergency charging request. Some implementations may stack all expropriated modules to service the emergency charging request, other implementations may selectively stack expropriated modules as needed.

In some cases, a vehicle's ongoing charging session and/or pending request may affect priority and/or severity. For example, ongoing charging sessions may be prioritized over pending charging requests; this ensures that ongoing charging sessions are not interrupted unless explicitly terminated. Alternatively, ongoing charging sessions may be de-prioritized relative to pending charging requests. This may allow for more fluid re-allocation (e.g., emergency charging can be readily re-configured with a new request, rather than terminating an existing charge session).

While emergency charging is assumed to be rare, there are certain circumstances that occur which can create large surges in demand. For example, site-specific events (e.g., a natural disaster, power outage, etc.) may affect many vehicles of the fleet all at once. In such cases, many vehicles may each launch emergency charging requests resulting all of which would have the same expropriation authority. In these “indeterminate” situations, power modules may need to be shared and/or split to service the requests.

In one specific embodiment, sharing and/or allocation schemes may be based on a site configuration. Site configuration for sharing and/or allocation may also be manually tuned to address a system-wide or site-wide emergency by a site administrator, machine logic, etc. There are a variety of different schemes, the following discussions being purely illustrative.

One allocation scheme might share power modules when severity equals priority, otherwise power modules may be mapped to requesters one at a time. A first-come-first-served allocation might charge the first requester to a threshold state of charge (SOC) before addressing subsequent requesters (held in pending state). A first-come-only-served allocation would only allow one emergency charge session at a time, subsequent requests (new charging session requests where priority equals severity) may be denied and must be re-requested later. A last-come-first-served allocation may automatically service the most recent requester (earlier requesters are held in pending). “Sharing” schemes distribute power modules between multiple requesters according to some mapping—mappings may not be equal. For example, two emergency requests might share 5 power modules according to a 3:2, or even a 4:1, division. In some cases, unequal sharing may consider factors such as priority, plug-in time, SOC, minimum allocations, maximum allocations, etc. Allocation and sharing schemes may be re-evaluated whenever any terminating event occurs (discussed below).

Once expropriated, the requesting vehicle(s) begin emergency charging until a termination event, called a relinquishment event in FIG. 2, occurs (step 208). Terminating events are conditions that end the emergency charging session. In some cases, terminating events may be configured in advance. For example, vehicle may have a set SOC threshold (e.g., 70%, 90%, etc.) and/or charging time (e.g., 30 min, 1 hr, etc.). Other termination conditions may be implemented for safety and/or flexibility. Examples may include charging errors (GFCI, EVSE fault, etc.), as well as administrator overrides and/or driver cancellations. For example, administrator settings may ignore emergency charge requests from PHEVs; similarly, a driver may have the option to terminate an emergency charging session—this may require the driver to re-authorize. Logs and or notifications of the termination event may include a completion status; this may be used to review whether the emergency session intended due to charge completion, or where terminated, the cause of termination.

Once terminated, the expropriated resources are relinquished (step 210). As used herein, “relinquishment” and its linguistic derivatives refers to the release of direction or control by the authority. Relinquishment may or may not result in re-mapping of resources (e.g., the stacked mapping of power modules may persist).

In the depicted logical flow, evaluation occurs responsive to an emergency request, but re-evaluation may occur after relinquishment. The depicted implementation does not automatically evaluate/re-evaluate whenever e.g., a new fleet vehicle plugs-in, etc. Here, expropriation requires an “active” request to be made, whereas relinquishment may occur as a “passive” process. Other implementations may implement emergency charging schemes that are passive (e.g., a vehicle or user always receives emergency charging, regardless of request). More generally, the depicted flow assumes that emergency charging is relatively rare and is actively requested. Nonetheless, triggers that assume other levels of emergency frequency and/or user interaction may be substituted with equal success. For example, re-evaluation may be performed periodically, triggered by another vehicle plugging-in, etc.

As discussed above, relinquished power modules may be re-mapped to their originally assigned port (e.g., a 1:1 mapping). Alternatively, the relinquished power modules may be re-mapped to handle the next queued emergency charging scenario. Still other implementations may allow for relinquishment to a common resource pool and/or continued charging in the stacked configuration at default priority (nominal), etc.

A variety of different expropriation scenarios are provided in APPENDIX A, incorporated herein by reference in its entirety.

### 2 Emergency-Aware Load Control Management System (LCMS)

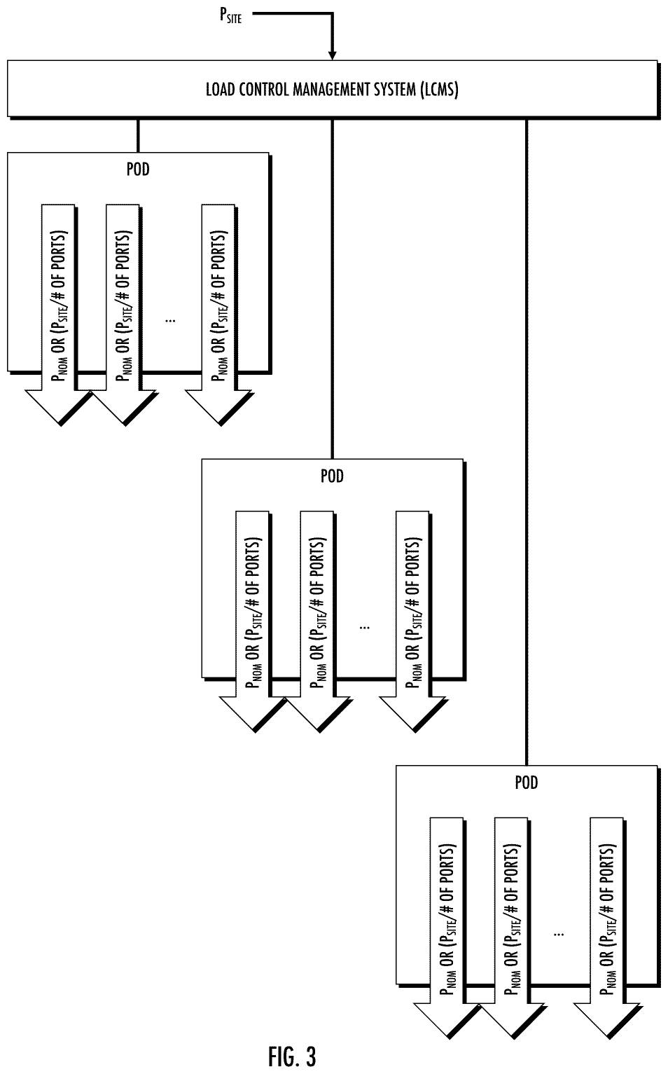

A load control management system (LCMS) refers to site-wide logic that manages the overall power usage. FIG. 3 provides a logical system diagram useful to explain conventional LCMS operation. Under normal conditions, each port of the site can provide its nominal power (Pₙₒₘ). However, there are circumstances where the port must provide reduced power output.

In one such example, a site may have more ports or nameplate charging power than it can fully power—for example, a site may have a 1.0 MegaWatt (MW) capability but 100 20 kW ports totaling 2.0 MW nameplate charging power. Each power module may have a nominal power capability of 20 kW; up to 50 ports may be utilized at their nominal capability. However, if more vehicles are concurrently being charged, then the conventional LCMS evenly distributes power across the power modules. For example, 75 charge sessions (75% utilization) results in a 13.3 kW allocation to each power module. Similarly, the site's total power (Pₛᵢₜₑ) may be throttled down by an external demand response imposed by the grid or a market-based demand response program. Much like the over-subscribed scenario, the conventional LCMS operation distributes the demand respond reduction equally across all power modules. In other words, a 75% demand response reduction of a 20 kW power module would result in 13.3 kW output.

Unfortunately, conventional LCMS operation directly affects stacking of power modules. In other words, a port with 10 stacked power modules of 20 kW would expect to generate an emergency charging output of 200 kW; however, conventional LCMS throttling would directly reduce that amount.

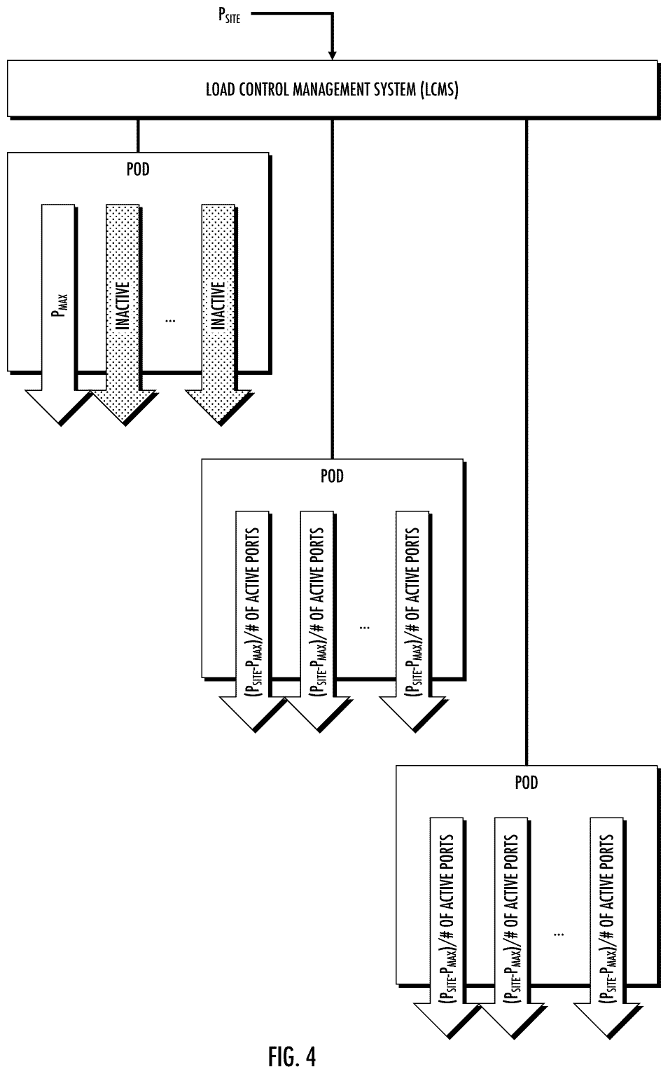

FIG. 4 provides a logical system diagram useful to explain emergency-aware LCMS operation. In this case, an emergency request by a single vehicle received at one pod causes the pod to divert all of its power modules to a single port. In addition, the emergency-aware LCMS fully powers the expropriated power modules—e.g., an emergency charging port with 10 stacked power modules of 20 kW would generate an emergency charging output of 200 kW (up to the port's Pₘₐₓ). The other ports of the same pod are marked inactive until the emergency charging session is over. The emergency-aware LCMS may also distribute the remaining power (Pₛᵢₜₑ−Pₘₐₓ) across the remaining active non-emergency ports of the other pods. So, in this example, there are 100 total ports at a 1.0 MegaWatt (MW) site with 1 emergency charge session, 49 inactive ports, and 50 active non-emergency ports. The site would distribute the surplus (1.0 MW−200 kW=800 kW) across 50 ports, resulting in 16 kW to the non-emergency ports of the other pods.

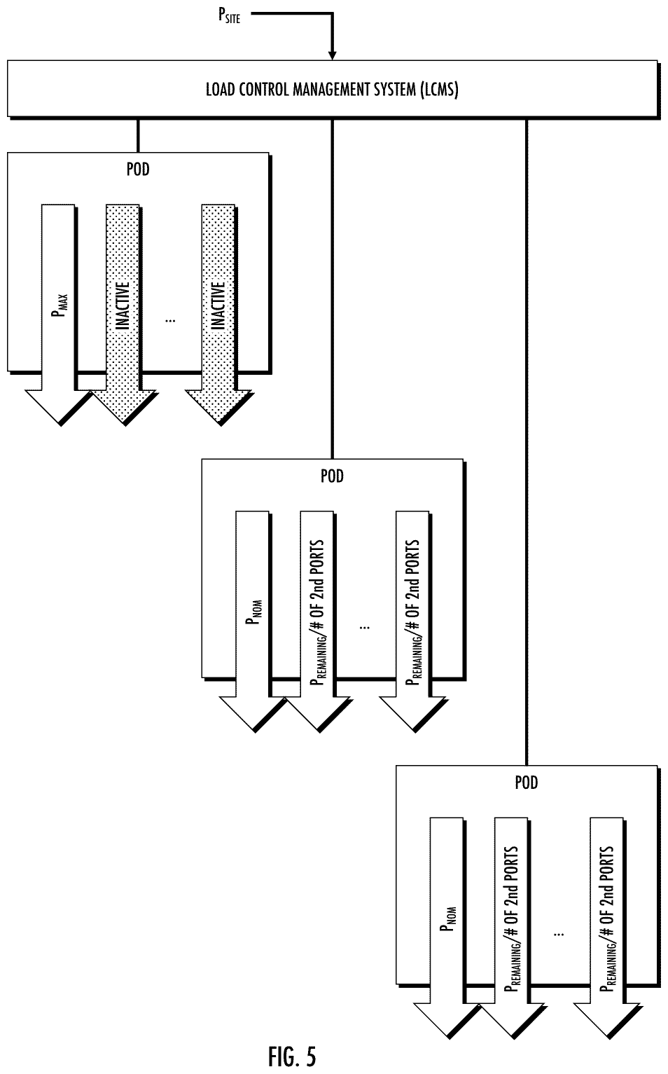

The exemplary techniques may modulate power sourcing to power modules based on priority and severity. In fact, these concepts may be broadly extended to non-emergency prioritization as well. As shown in FIG. 5, a first pod has one emergency charging session (one active port at Pₘₐₓ), the LCMS may then identify a number of charging sessions that are non-emergency but have priority over other non-emergency sessions. Non-emergency sessions map power modules to ports 1:1. The prioritized charging sessions may each have their power modules powered to their nominal power (Pₙₒₘ)—in this example, Pₙₒₘ is used for 2 prioritized non-emergency ports. The non-prioritized charging sessions may divide the remaining power (1.0 MW−200 kW−20 kW−20 kW) across 48 ports, resulting in 15.8 kW.

More broadly, various aspects of the present disclosure extend the concepts of priority and/or severity to site-wide power management. Conceptually, power may be distributed to power a first priority, before distributing the remaining power to the next priority, etc. This isolates the first prioritization level from internal and/or external throttling. In some variants, power distribution at one level may be fully fulfilled before addressing subsequent levels. In other variants, a minimum power distribution for each level may be guaranteed.

### 3 System Architecture

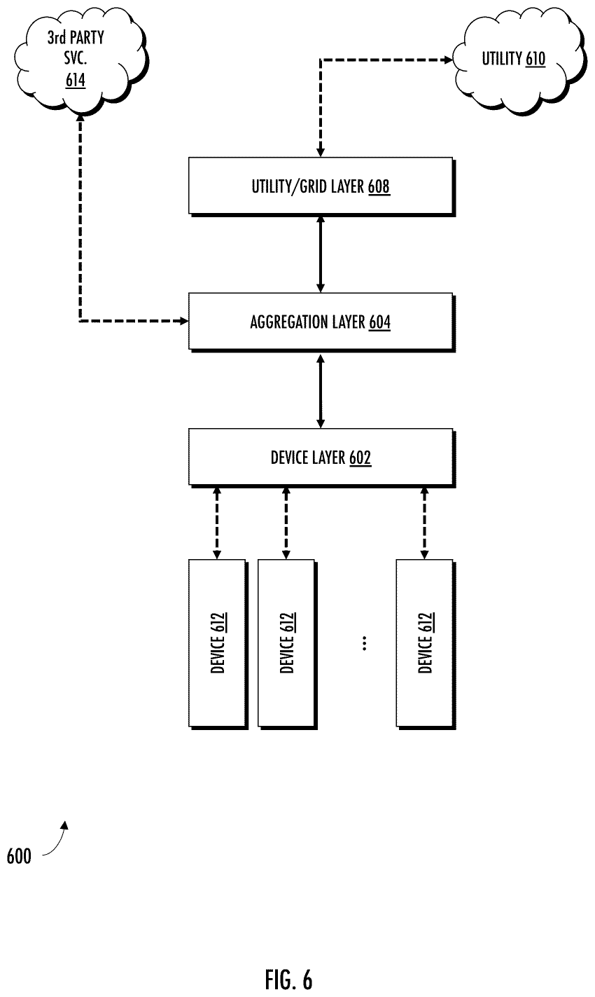

FIG. 6 is a logical block diagram of a distributed power management system 600. The distributed power management system 600 may be implemented as a layered software architecture. The illustrated implementation is divided into: a device layer 602, an aggregation layer 604, and a utility/grid layer 608. The distributed power management system 600 coordinates interactions between utility providers 610, 3^{rd} party services 614, and devices 612. In one specific implementation, the distributed power management system 600 enables intelligent control and interoperability for distributed energy resource (DERs); this allows the grid to operate as a flexible and dynamic ecosystem.

As a brief aside, a distributed network is a system composed of multiple nodes that operate independently but communicate with one another. Each node is an individual computing unit or device capable of processing data and making decisions locally. The network refers to the structured set of connections that enables data exchange between nodes.

Within the context of the present disclosure, a distributed energy resource (DER) is an electricity-producing, electricity-consuming, and/or electricity-managing resource that is the closest logical node to the point of use (also referred to as “behind the meter” or the “edge” of the network). More generally, however, a “node” is any logically addressable entity of the distributed network—in fact, some physical devices may house multiple logical nodes e.g., a device could include both a DER node and a device layer, each one addressable as an individual node.

Notably, utility providers face significant challenges in transitioning to DER-based energy management due to the shift from centralized, one-way power flow to a decentralized, dynamic grid with millions of DERs. This introduces complexity in forecasting, real-time control, and system stability, as utilities must coordinate diverse and often customer-owned assets like solar, batteries, and EV chargers. Interoperability across heterogeneous devices, cybersecurity risks from expanded attack surfaces, and the need for new standards and regulatory frameworks further complicate integration. Additionally, legacy infrastructure and operational models often lack the agility to support fast, two-way communication and decentralized dispatch, requiring major upgrades in IT systems, workforce training, and grid planning methodologies.

During distributed power management system 600 operation, the device layer 602 manages the edge of the network (e.g., electric vehicle supply equipment (EVSE), chargers/inverters, batteries, etc.). For example, the device layer 602 may be installed within a charging pod/tower that directly interfaces with a DER (e.g., the DC EV chargers at a depot, the charger logic inside an electric vehicle, etc.). The aggregation layer aggregates DERs from multiple sites and/or customers; this enables multi-party control, device virtualization, grid market integration, etc. In some variants, the aggregation layer may also expose APIs that enable 3^{rd} party services 614 to coordinate the operation of the distributed power management system 600. The utility/grid layer 608 coordinates the operation of the distributed power management system 600 with the utility providers 610. In some variants, the distributed power management system 600 may enable topology-aware DER control for utility providers 610 and/or 3rd party services 614.

The illustrated software architecture of FIG. 6 is organized into distinct functional layers (layering) of modular components. Modular components may be mixed and matched, added, removed, or upgraded without affecting other portions of the system (e.g., different devices may communicate with different device layer software, etc.). Similarly, each layer is decoupled from other layers, allowing updates or changes within one layer without affecting others. While the illustrated system is presented in the context of a composable, layered software architecture, artisans of ordinary skill in the related arts will readily appreciate that other implementations may use other topologies and/or subdivide, combine, augment, and/or otherwise modify functionalities with equal success.

Modularity may be implemented with application programming interfaces (APIs) and/or other software abstraction techniques. APIs (Application Programming Interfaces) serve as structured interfaces that allow different software systems to communicate, exchange data, and invoke functions in a standardized, secure, and scalable manner. They may define endpoints through which external platforms, applications, or devices can access data and/or control for a system without needing access to its internal codebase. In some implementations, APIs may operate using RESTful or RESTful-like web services over HTTPS.

RESTful refers to systems or APIs that use REST (Representational State Transfer) architectures for stateless web services. A RESTful API allows clients (like apps, dashboards, or devices) to interact with a server over HTTP using a set of well-defined operations-typically the standard HTTP methods: GET (read), POST (create), PUT/PATCH (update), and DELETE (remove).

Within the context of the distributed power management system 600, clients for RESTful web services (e.g., utility systems, fleet dashboards, or billing platforms) send requests to API endpoints and receive structured responses-typically in JSON or XML format. These APIs authenticate users or systems via tokens or certificates, enforce permission scopes, and validate payloads before executing logic. RESTful operation enables interoperability between distributed systems. Some variants may also implement versioning and access control to ensure APIs are e.g., performant, backwards-compatible, secure, and/or flexibly support multi-stakeholder environments.

More generally, artisans will readily appreciate that other APIs and/or control/data interfaces may be substituted with equal success, the foregoing discussions being purely illustrative. Other examples may include e.g., query-based schemas, remote procedure calls, simple object access protocols, publication-subscription interfaces, shared memory/function call interfaces, etc.

As a brief aside, the terms “distributed” and “centralized” and their linguistic variants refer to a broad spectrum of techniques for organizing control and/or data within a network of nodes. For example, some distributed systems may centralize control of node behavior but distribute data processing. Other systems may centralize data processing but allow each node to independently control its own behavior. Various other systems may perform a hybrid of control and/or data. More generally, the various techniques described throughout may have broad applicability to a variety of coordination topologies for a variety of different applications.

The following discussion provides functional descriptions for each of the logical entities of the distributed power management system 600. Artisans of ordinary skill in the related arts will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the distributed power management system 600 is separately provided below.

### 3.1 Device Layer

As a practical matter, the distributed energy resource (DER) ecosystem spans many different technologies and architectures. For example, DERs, EVs (electric vehicles), solar batteries, etc. may each have their own protocols and/or capabilities. Functionally, the device layer 602 enables device-specific communication to/from other software layers. The device layer 602 secures communications between its device endpoint and other network endpoints, over an unsecure network (e.g., the Internet). Security ensures that e.g., systems are protected from cyberattack, data is kept private, etc. The device layer 602 may additionally standardize communication protocols across different endpoints to higher layer software (e.g., aggregation layer 604, utility/grid layer 608). Standardization avoids device-specific integrations at other entities. Furthermore, the device layer 602 may handle embedded and/or real-time specific requests—these types of requests may have time constraints that are difficult/infeasible to handle across best effort networks.

Spark is Kitu Systems' device-layer software implementation. Spark embeds intelligence, security, and interoperability directly into distributed energy resources (DERs) such as EV chargers, solar inverters, and batteries. Spark enables standards-based communication (e.g., IEEE 2030.5, CSIP, OCPP), end-to-end cybersecurity, and local control logic. It is typically installed either within the device itself, or on an adjacent gateway, etc.

In one specific implementation, the device layer 602 is implemented as a software agent that locally executes on a physical device. For example, each one of the multiple pods 102 and/or multiple towers 104 of FIG. 1 may include a local software agent running the device layer software agent. Other examples may include software agents that execute locally on a DER or associated gateway (e.g., rooftop solar system, battery system, etc.).

As a brief aside, software is typically implemented as non-transitory computer-readable instructions that are executed by a processor. Software may be used to read/write and store data to effectuate calculations and/or actuation of other components. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As a practical matter, different processor architectures are optimized for specific patterns of processing. For example, a general-purpose CPU may be primarily used to control device operation and/or perform tasks of arbitrary complexity/best-effort. CPU operations may include, without limitation: general-purpose operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks and must account for branch disruption and/or arbitrary memory access.

Other processor architectures may be optimized to perform many of the same tasks repeatedly over a well-defined data structure. More specialized logic can often result in much higher performance (e.g., by avoiding unnecessary operations, memory accesses, and/or conditional branching). For example, a GPU may be heavily pipelined (seldom branches) and may incorporate specialized vector-matrix logic. As another example, DSPs may be highly parallelized and/or constrained by real-time budgets. Still other processing logic may be substituted with equal success by artisans of ordinary skill in the related arts. Other processor implementations may also multiply, combine, further sub-divide, augment, and/or subsume the various functionalities within these or other processing elements.

A memory subsystem may be used to store data. For example, data may be stored as non-transitory symbols (e.g., bits read from non-transitory computer-readable mediums.) In one specific implementation, the memory subsystem including non-transitory computer-readable medium is physically realized as one or more physical memory chips (e.g., NAND/NOR flash) that are logically separated into memory data structures. The memory subsystem may be bifurcated into program code and/or program data. In some variants, program code and/or program data may be further organized for dedicated and/or collaborative use. For example, a GPU and CPU may share a common memory buffer to facilitate large transfers of data therebetween, etc.

In some embodiments, program code may be statically stored within a device as firmware. In other embodiments, the program code may be dynamically stored (and changeable) via software updates. In some such variants, software may be subsequently updated by external parties and/or the user, based on various access permissions and procedures. While the following discussion describes a software implementation, hardware implementations and/or programmable logic implementations may be substituted with equal success.

Referring back to FIG. 6, the device layer 602 may include a security and access control module. The security and access control module interfaces with the DER hardware to ensure that communication between distributed energy resources (DERs) and upstream platforms (described elsewhere) is secure, authenticated, and policy-compliant. It implements end-to-end encryption using e.g., TLS, enforces mutual authentication via device certificates, and/or manages role-based access control (RBAC) to ensure that only authorized entities (e.g., utilities, aggregators, or site operators) can read data from or send control commands to the device.

In one specific implementation, the security and access control module is implemented locally at the edge device, which allows for autonomous enforcement of access policies even if the device is temporarily disconnected from the cloud. While edge device implementations enhance local control, resilience, and low-latency enforcement, it also imposes constraints on processing power and memory which can be an issue for low-resource devices like inverters or EVSEs. In some variants, the security and access control module may be adaptable, allowing it to balance robust cryptographic protections with the performance limitations of embedded environments. In one specific implementation, the security and access control module may implement IEEE 2030.5; other protocols may be substituted with equal success.

The device layer 602 may include a protocol adapter module to interface to the device hardware. The protocol adapter module translates between device-native protocols and standardized grid communication protocols. Its implementation may include support for industry standards (e.g., OCPP, SunSpec Modbus, IEEE 2030.5, OpenADR, etc.). This module dynamically maps internal device functions-such as telemetry reporting, control commands, or status updates—to externally recognized protocol messages, ensuring that the device behaves in a grid-compliant and vendor-agnostic manner. Supporting multiple complex protocols increases code size and memory requirements can strain resource-constrained embedded hardware. Thus, some variants may use a modular protocol stack, enabling device manufacturers to include only the protocols necessary for a given application; this optimizes for both performance and compliance without bloating the firmware.

The device layer 602 may include a device logic and control module. The device logic and control module interfaces with the native device hardware to execute local control decisions and implements grid-interactive behaviors directly on distributed energy resources (DERs). It may interpret incoming commands-whether from utilities, aggregators, or site systems—and apply them in accordance with device capabilities, policy constraints, and current operating conditions. The module may also enforce autonomous responses to local events, such as voltage fluctuations or frequency deviations, by implementing standard inverter and DER behaviors (e.g., Volt/VAR, frequency droop, curtailment) as defined by protocols like IEEE 2030.5 and IEEE 1547.

In some variants, the device logic and control module is an embedded logic that executes directly on the edge device (and may not require persistent cloud connectivity). Embedded designs may have real-time scheduling to support low-latency response and may support grid compliance even in “islanded” or offline conditions. Some variants may allow for configurations that e.g., support evolving standards, ensure deterministic and certifiable behavior across a wide range of hardware platforms, etc.

The device layer 602 may include a telemetry and monitoring module. The telemetry and monitoring module provides real-time visibility into the performance, status, and health of distributed energy resources (DERs) at the device level. It collects operational data-such as power output, voltage, state of charge, temperature, fault conditions, and connectivity status—and transmits this information securely to upstream platforms. Variants may perform periodic and/or event-driven reporting. In some cases, reporting may balance communication bandwidth with the need for timely updates. Reporting may comply with e.g., standards like IEEE 2030.5 and SunSpec Modbus. In some variants, the telemetry and monitoring module may also include fault detection and logging, to help diagnose issues remotely and improve fleet reliability.

Reporting may have varying levels of granularity and/or frequency. More frequent or detailed telemetry enhances visibility and control but can strain low-bandwidth connections and increase energy or memory usage on constrained devices. Some variants may support configurable telemetry profiles, allowing manufacturers, fleet operators, etc. to tailor reporting intervals and data sets based on application needs, communication infrastructure, and compliance requirements. Other variants may allow for internal logging and/or time-delayed reporting.

The device layer 602 may include a provisioning and lifecycle management module. The provisioning and lifecycle management module manages the onboarding, configuration, and long-term operational state of a DER throughout its lifecycle—from initial deployment to firmware updates and decommissioning. It assigns a trusted identity for each device using certificate-based authentication, enrolls it into authorized networks (e.g., utility, aggregator, site operator), and maintains configuration integrity across power cycles, resets, or network interruptions. It manages secure storage of credentials, configuration parameters, and versioned policy sets, and enables over-the-air (OTA) updates to firmware or software components.

The foregoing discussion of device layer 602 is purely illustrative, various other functionalities and/or implementations may be substituted by artisans of ordinary skill, given the contents of the present disclosure.

### 3.1.1 Intra-Fleet Allocation

Aspects of the present disclosure modify the device layer 602 for dynamic intra-fleet allocation schemes. In one embodiment, the intra-fleet allocation scheme is encoded into numeric values for severity (node-specific) and priority (fleet-assigned)-devices can use these numeric values to communicate and negotiate their needs and available surplus with the device layer 602. These concepts may be broadly extended to any device level implementation of intra-fleet resource allocation.

Here, “intra-fleet”, “intra-site”, and their linguistic derivatives refers to internal coordination (e.g., control decisions, etc.) among a set of nodes associated with a single fleet/site. As previously noted, a “fleet” refers to a plurality of entities that are directed and/or controlled by a common authority (“fleet authority”).

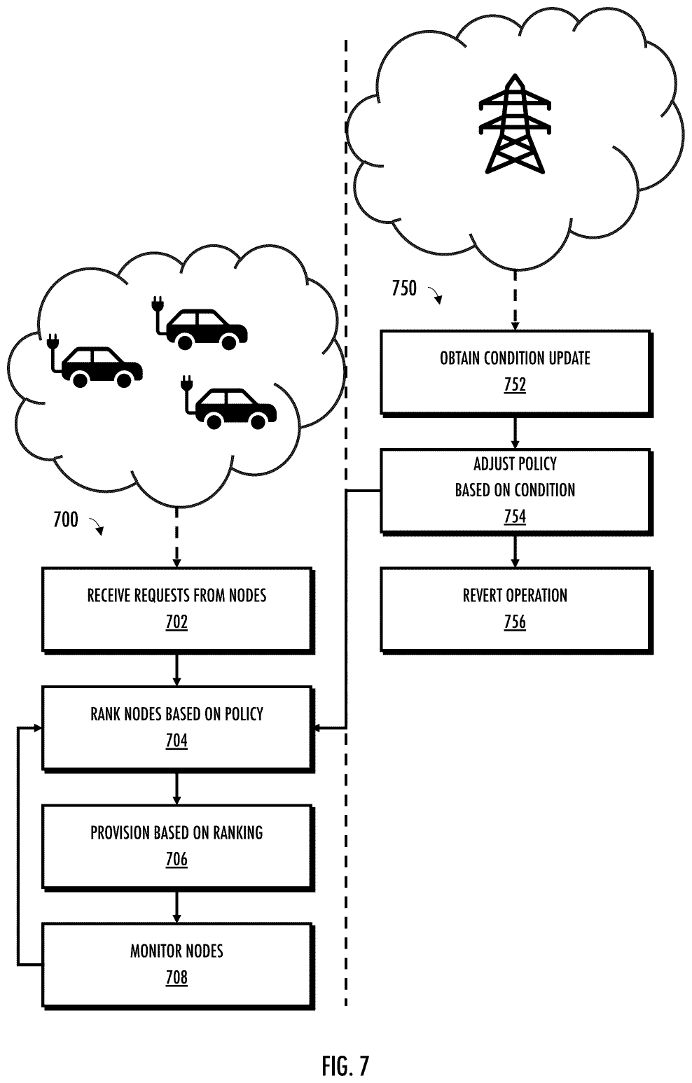

FIG. 7 depicts a first routine 700 that dynamically manages intra-fleet resource allocation. While the following discussion is presented in the context of one routine, the first routine 700 may be separated into multiple processes (and performed by e.g., different subsystems of the device layer 602) and/or may be combined with other processes or further subdivided into other processes with equal success. Additionally, the following steps are discussed in the context of software instructions stored on memory and executed via a processor, however alternative implementations may use dedicated hardware (combinatorial and sequential logic) and/or firmware (software/hardware hybrids).

In one embodiment, a non-transitory computer-readable medium includes a first routine 700 that dynamically manages intra-fleet resource allocation. When executed, the first routine 700 causes the device layer 602 to: receive requests from nodes, rank the nodes based on an intra-fleet policy, provision resources based on the intra-fleet policy, and monitor resource provisioning to the nodes.

In some variants, the first routine 700 is executed within a localized software agent; in other variants, the first routine 700 is localized to a processor or similar control logic under control of the fleet authority, utility provider, or other common entity. Still other variants may implement portions of the routine across multiple entities (e.g., stakeholders) via cloud services, etc.

At step 702, the device layer 602 receives requests from nodes. In the previously described embodiments, distributed energy resources (DERs) (e.g., electric vehicles) request power from a tower of a pod. The tower can dynamically map power distribution from power modules; stacking together modules to deliver more power when desired (see e.g., FIG. 1 and related discussions above).

More generally, the concepts may be extended to any set of nodes (e.g., a fleet) which make resource requests (for e.g., power modules) that are associated with a common entity (e.g., a fleet authority). These concepts may be extended to a variety of distributed behind-the-meter style management applications (e.g., multi-dwelling residential, commercial, agricultural, etc.) and/or utility services (e.g., electricity, gas/material usage, water, connectivity, waste removal, etc.).

In some embodiments, requests are queued for service. Queues may be useful where the available resources may not always completely service the set of requests. The queue may order requests based on e.g., order of arrival (first-come-first-served), wait time (last-in-first-out), severity/priority, and/or any other scheme. In some variants, the queue may have a default order that can be re-ordered in response to an event. For example, a fleet depot might service charging requests on a first-come-first-served basis by default but switch to severity/priority when one or more emergency requests are received. Other variants may order/re-order the queue periodically, as-needed, as-requested, etc.

In some embodiments, each request may be associated with a severity level. Within the context of the foregoing examples, severity allows the requesting node to convey its urgency (the node-specific impact). In the exemplary embodiments, a non-emergency severity could refer to nominal charging levels (varies across batteries but typically e.g., 20%-90%, 30%-80%, etc.) that are selected to avoid deep discharges and overcharges which reduce battery lifetime. Emergency severity may refer to charge levels that are required to perform a function or prevent system failure; emergency charging occurs at lower thresholds than non-emergency charging (e.g., 10%, 20%, etc.). Critical emergency may refer to any charge level below emergency thresholds.

Different technologies may have different ways to assess severity; e.g., electric-only vehicles may consider low charge a critical emergency, hybrid vehicles may consider low charge a normal emergency since they can provide fallback functionality with an internal combustion engine, etc. More broadly, severity may be assessed in a variety of different ways. A node may consider functional impact, scope of impact, duration of impact, system risk/safety, compliance and/or regulatory impact, financial impact. Some schemes may use a consistent severity scale—e.g., the requests may be mapped to a numeric value representing the severity according to the shared rule set promulgated by the fleet authority. Other schemes may use severity levels that are defined by the user, battery manufacturer, utility grid, or other stakeholder entity.

Notably, a DER may understand its own needs but often is unaware and/or shielded from other DERs. Thus, the device layer 602 may assign a priority level (e.g., low, nominal, high, etc.) to the request in some embodiments. Generally, priority refers to a scheme for ordering items of a list (e.g., tasks, resources, processes, etc.). Prioritization schemes enable resource allocation for list-based processing. In fleet management applications, prioritization governs how resources are allocated to nodes of the fleet to optimize fleet-wise constraints like time, power consumption, bandwidth, and/or capacity. Thus, a device layer 602 might prioritize emergency vehicles over employee cars, or charging buses scheduled for early dispatch before others. In power systems, critical loads (e.g., hospitals or data centers) may receive priority during curtailment or restoration events.

Prioritization schemes can vary depending on context, but common models include fixed priority (predefined ranks that don't change), dynamic priority (priority changes based on conditions, such as state of charge or time to departure), round-robin (equal slices in rotation), and weighted fairness (each resource receives attention based on an assigned weight). Various other priority schemes may be substituted with equal success.

While the foregoing scenarios are based on node-initiated requests, other allocation schemes may be substituted with equal success. For example, a node may announce its presence, relying on another entity to grant/request resources. Within the context of DERs, some vehicles may consume and provide energy (e.g., an EV may support Vehicle-to-Grid (V2G)—a V2G EV may advertise that it has surplus power which may be injected back into the grid and/or invite neighboring nodes to request power if-needed, etc.)

Requests may be handled in real-time (according to time constraints) or at best effort (without time constraints). Other scheduling may be substituted with equal success; for example, resources may be handled according to a schedule, automated, recurring, event-driven, etc. As but one such example, a device layer 602 may consider requests for vehicles based on dispatch schedules and/or at specific events (changes in grid conditions, etc.).

Depending on implementation, a variety of additional checks may be implemented at e.g., the device layer 602 (in addition to, or in lieu of, checks at the aggregation layer or utility/backend layer). Examples of common check protocols may include, without limitation: validation, verification, authentication, authorization, accounting, etc. These steps may be especially important when dealing with a diverse and open ecosystem (e.g., bad actors, faulty devices, etc.). For example, validation may be used to ensure that the requests are properly formatted, fall within expected ranges, etc. Verification may be used to ensure that requests are not illicit and/or duplicative (e.g., commonly used in cyber theft, etc.). Authentication, authorization, and accounting is frequently used for intra-fleet (and in some cases extra-fleet) access control, etc.

At step 704, the device layer 602 ranks the nodes based on an intra-fleet policy. A “policy” is a codified set of rules, metrics, conditions, or instructions. In the previously described embodiments, the severity of the DER request may be compared to the defined priority levels to assess whether the request should be serviced. In other words, the intra-fleet policy is encoded as a shared rule set and metrics for severity and priority. Numeric values are defined for severity (node-specific) and priority (fleet-assigned)-devices can use these numeric values to communicate and negotiate their needs and available surplus. An “expropriation authority” may be calculated based on the difference between severity and priority. The expropriation authority is used to identify when a power module may be expropriated.

Alternative implementations may use an explicit formulation of intra-fleet policy—e.g., conditional statements, logical formula, and/or other heuristics that identify nodes that should be serviced, the amount of charging, etc. Still other implementations may use neural networks, machine learned logic, and/or other artificial intelligence solutions to allocate resources. Various other algorithms and/or processes may be substituted with equal success.

More generally, an intra-fleet policy may be used to score, or otherwise evaluate, a variety of considerations from a variety of different stakeholders. Node-specific information may be obtained from a node (a DER) as well as its associated device layer agent. Node-specific information may include node role, node status, request timing, and/or other request attributes. The device layer 602 may consolidate information across multiple nodes and may also incorporate information from upper layers (e.g., aggregation layer, utility/grid layer, discussed elsewhere). For example, the device layer 602 may dynamically respond to grid-wide issues (e.g., rate hikes, outages, etc.).

Other stakeholders (e.g., the user, the utility operator, etc.) might provide information that could be conveyed as numeric factors/modifiers for use in ranking. For example, a user might have application information (e.g., long distance may need more charge; a short distance might be ok with less charge); thus, the user could increase/decrease severity based on their knowledge. As another such example, the utility operator might have grid information that would impact the fleet's prioritization e.g., during surge pricing, priority levels could be increased by 1 to reduce the number of emergency charging sessions. While the foregoing examples are presented with increments/decrements, multiplicative scaling could be substituted with equal success. Other relationships may also be used e.g., time windowing, derivatives, integrals, non-linearities, etc.).

In the exemplary embodiments, the DER requests are ranked based on expropriation authority. Ranking is the process of ordering or re-ordering requests (or allocations) based on a defined set of criteria. Here, the intra-fleet policy serves as an ordering function for the severity/priority of requests; and identifies which (if any) power modules should be expropriated to satisfy the set of requests. Alternative algorithmic approaches might include e.g., machine learned models (ML models, multi-criteria decision-making, and/or other forms of artificial intelligence (e.g., reinforcement learning, etc.).

A variety of different ranking schemes may be used. As but one example, a pool of resources may be distributed to nodes based on a numeric ranking order. Resources may be distributed based on seniority; e.g., nodes with the highest score are serviced first, then nodes at the next highest score, etc. Resources may be evenly (or unevenly) distributed for nodes with the same seniority. A “fair” distribution might divide the pool of resources across nodes with the same seniority. A “greedy” distribution might attempt to completely satisfy a node request before servicing the next node at the same seniority. One specific implementation uses a first-come-only-served allocation that only allows one emergency charge session at a time. Subsequent requests of the same rank are denied and must be re-requested later. A similar implementation may use a last-come-first-served allocation that automatically services the most recent requester (earlier requesters are held in pending). Other uneven sharing schemes may e.g., distribute resources between nodes according to a fractional mapping (e.g., 2:3, 4:1, etc.).

Artisans of ordinary skill in the related arts will readily appreciate that these ranking techniques may be combined, substituted, and/or augmented with other techniques for allocation, assignment, configuration, and/or enablement of available resources for a set of nodes. Examples of alternative schemes include, without limitation, round-robin, quota, randomized, token-based, etc. As but one such example, the most senior nodes may share a pool of resources using a first round-robin, then the remaining resources may be distributed to the next most senior nodes using a second round-robin, etc.

At step 706, the device layer 602 provisions resources based on the ranking. In the previously described embodiments, power modules are mapped (or re-mapped) to ports based on expropriation authority. In one specific embodiment, the charging equipment (e.g., fast charger, etc.) begins to draw power from the grid. A fast charger rectifies incoming AC power to DC power, and performs power conditioning (e.g., filtering, step up/down transforms, peak shaving, load balancing, etc.).

Within the context of power distribution, power modules may be stacked to achieve higher power output (but not exceeding) the maximum power capability of a port (designated as an “emergency charging port” (ECP)). Stacking may be implemented in series (additive voltage, consistent current draw), parallel (consistent voltage, split current draw), or some combination thereof. Analogous functionality may be used for other systems; e.g., pumps may be used to deliver liquids (e.g., water, gas, oil, etc.) at higher volumetric flow, codec processing/spectrum may be used to deliver higher bitrates, etc.

At step 708, the device layer 602 monitors resource provisioning to the nodes. In the previously described embodiments, the DER (and/or device layer) monitors a state of charge (SOC) to determine whether a relinquishment event has occurred.

Monitoring schemes may check for a variety of different terminating conditions. Monitoring may be continuous, periodic, scheduled, as-needed, as-requested, etc. Conditioning circuits may monitor for grid conditions (via IEEE 2030.5 and/or other communication protocols) and/or coordinate charging to match grid availability. In some cases, the charging equipment may additionally tap into secondary sources of power (e.g., stored power in battery packs, capacitors, flywheels, etc.). In addition to grid availability, the charging equipment may also monitor the DER endpoint to ensure that charging is proceeding within safe limits. The DER and device layer may communicate to ensure that temperature remains at a safe level, state of charge is increasing at expected rates, etc. The device layer 602 may communicate with the DER using equipment specific protocols, and report status back to higher layers.

Notably, encoding the intra-fleet allocation scheme as numeric values enables the device layer 602 to rank charging requests locally. Local operation may be useful for real-time operation (e.g., where decisions must be made under time constraints), and/or during network outages. Other local implementations of conditional statements, logical formula, neural networks, machine learned logic, and/or other artificial intelligence solutions may be substituted with equal success.

In some embodiments, a node may terminate its request once its need has been satisfied. Alternatively, the device layer 602 may terminate the request in favor of servicing other more senior requests. Some implementations may allow for manual termination (e.g., from a user), and/or higher layer termination (e.g., from an aggregation layer, utility/grid layer, etc.).

In one specific embodiment, a relinquishment event allows the device layer 602 to return to a default policy. In other words, the emergency charging ordering may only be used when there is at least one emergency request. Once all the emergency requests have been serviced, the fleet depot may return to its normal ordering schemes.

The various techniques described throughout enable a fleet authority to dynamically modify its allocation schemes as-needed. Here, the default ordering scheme (e.g., order of arrival (first-come-first-served), wait time (last-in-first-out), etc.) may be selected to e.g., reduce costs, ensure availability, etc. However, the fleet authority may switch to a severity/priority scheme to handle less common situations (emergency). More broadly, the fleet authority may use any number of different triggers and/or conditions to change its intra-fleet policy for resource allocations.

### 3.1.2 Extra-Fleet Conditions

Aspects of the present disclosure modify the device layer 602 to dynamically adjust the intra-fleet policy based on extra-fleet conditions. Here, “extra-fleet”, “extra-site”, and their linguistic derivatives refers to conditions that are external to the fleet/site. Extra-fleet conditions may be considered in combination with, or isolation from, intra-fleet allocations. For example, some embodiments may dynamically adjust intra-fleet allocations based on extra-fleet conditions, whereas other embodiments may only consider extra-fleet conditions or intra-fleet allocations in isolation.

FIG. 7 depicts a second routine 750 that dynamically manages a policy based on extra-fleet conditions. While the following discussion is presented in the context of one routine, the second routine 750 may be separated into multiple processes (and performed by e.g., different subsystems of the aggregation layer 604) and/or may be combined with other processes or further subdivided into other processes with equal success. Additionally, the following steps are discussed in the context of software instructions stored on memory and executed via a processor, however alternative implementations may use dedicated hardware (combinatorial and sequential logic) and/or firmware (software/hardware hybrids).

In one embodiment, a non-transitory computer-readable medium includes a second routine 750 that dynamically manages a policy based on extra-fleet conditions. When executed, the second routine 750 causes the device layer 602 to: obtain extra-fleet condition update, adjust a policy based on the extra-fleet conditions, and revert operation.

In some variants, the second routine 750 is executed within a localized software agent; in other variants, the second routine 750 is localized to a processor or similar control logic under control of the fleet authority, utility provider, or other common entity. Still other variants may implement portions of the routine across multiple entities (e.g., stakeholders) via cloud services, etc.

At step 752, the device layer 602 obtains an extra-fleet condition update. In the exemplary embodiments, extra-fleet condition updates are received from an aggregator (via aggregation layer 604) or a utility/grid operator (via utility/grid layer 608) via communication protocols (e.g., Open Automated Demand Response (OpenADR), IEEE 2030.5, and/or proprietary APIs, etc.). In one specific implementation, the extra-fleet condition may affect the amount, availability, quality, or cost of resources that the fleet authority may allocate. For instance, a DR signal affects the total power available for a fleet depot to divide among its charging requests.

More generally, however, the concepts may be broadly extended to any condition, circumstance, or other factor of interest to the site/fleet operator. Examples of extra-fleet conditions may include, without limitation, the state of energy resources, time-based factors, site and infrastructure constraints, operational priorities and business policies, grid/market signals, environmental and/or other conditions. For example, market activity may change the amount/rate of profitable power generation. Customer demand may widely vary depending on end use applications.

In some cases, the device layer 602 may request or pull information to infer extra-fleet conditions. For example, a pod/tower may sense or pull local weather reports to determine periods of strain and/or generation opportunities. In another such example, the pod/tower may use predictive data to plan for vehicle needs, etc. For example, a fleet of vehicles may receive customer reservations, that can be used to forecast likely usage. In other cases, the device layer 602 may store and/or analyze historic information to infer extra-fleet conditions. For example, historic trends may be used to predict daily, weekly, monthly, yearly usage. While weather and usage are factors that drive resource demand, resource supply may be predicted based on e.g., oil prices, energy generation (wind, solar, etc.), and/or other factors.

At step 754, the device layer 602 adjusts an intra-fleet policy based on the extra-fleet condition. As previously noted, conventional load control management system (LCMS) evenly distribute power across its power modules; in other words, a 75% DR reduction would affect all charging ports, and proportionately affect stacked charging ports. In contrast, the exemplary LCMS described above changes the incidence of a demand response (DR) reduction to minimally impact its emergency charging DERs. In one such case, the exemplary LCMS diverts all of its resources (or the maximum resources the DER can handle) to service an emergency charging request. The remaining power is spread across the non-emergency DERs.

Conceptually, the techniques described throughout enable the device layer 602 to manage and control the incidence of extra-fleet conditions on its serviced nodes. In other words, the device layer 602 may shift the incidence of extra-fleet conditions such that some nodes may be more (or less) affected. As used herein, the term “incidence” and its linguistic derivatives refers to the impact of a condition, burden, or other load borne by an entity based on a specified distribution or interaction mechanism.

In one embodiment, the device layer 602 divides its serviced nodes based on the intra-fleet policy. In one specific implementation, the device layer 602 splits the serviced nodes based on severity (e.g., node specific impact). In other implementations, the device layer 602 splits the serviced nodes based on priority (e.g., a fleet assigned value). Still other implementations might split the serviced nodes based on some combination of severity and priority (e.g., based on expropriation authority, etc.). More generally, a variety of different types of information may be used to divide the serviced nodes into multiple subgroups. Node-specific information might include e.g., node types (e.g., electric vehicle (EV), solar battery, etc.), node status (e.g., state of charge (SOC), battery health, etc.), application type (e.g., short range, extended range, etc.), user type/permissions (e.g., visitor, employee, etc.), etc. Fleet-specific information might include e.g., available vehicles, grid/utility information (e.g., demand response signals, grid demand, grid failure, etc.), operational expense, backup information (e.g., generator availability, etc.).

Consider, for example, a scenario where the device layer 602 splits its serviced nodes into at least a first subset (non-emergency node(s)) and a second subset (emergency node(s)). Here, the second subset of vehicles (emergency) are charged with stacked power modules at full power (o % incidence); the first subset of vehicles (non-emergency) divide whatever remaining power is available (100% incidence). Other schemes may adjust incidence across the groups so that the non-emergency charging vehicles may feel most, but not all, of the demand response incidence. In fact, some scenarios may even have third or more subset(s) of nodes (critical emergency node(s), etc.); in these cases, the third subset (critical emergency nodes) may experience no impact (o %), the second subset (standard emergency nodes) might experience some impact (˜20%) while still remaining at a higher power level compared to the first subset (non-emergency nodes) which bear the bulk of the demand response (˜80%).

While the foregoing example adjusts the intra-fleet policy to change the incidence of the extra-fleet condition, other schemes may be substituted with equal success. For example, some systems may enable secondary power systems (e.g., causing some DERs to provide power using vehicle-to-grid (V2G)). Other systems may disable a number of e.g., pods, towers, dispensers, ports, and/or power modules, etc. to keep other power modules operating at full power. Still other variants may combine these approaches; for example, emergency chargers may have full power stacked charging based on grid power, whereas non-emergency chargers divide the remaining grid power and V2G power.

At step 756, the device layer 602 reverts to the normal operation. Reversion may occur because the extra-fleet condition has expired (e.g., demand response (DR) event ends). For example, most DR signaling may include a duration (15 min, etc.). After the DR event, the device layer 602 may revert back to the appropriate intra-fleet policy. Other systems may explicitly signal the end of a DR event and/or use event-driven logic, etc. For example, there may be circumstances where a network outage occurs during a DR event; in these situations, the device layer 602 may either assume that the DR event is continuing or may revert back.

Reversion may also be triggered by an intra-fleet event. For example, once an emergency charging request has been fulfilled, the node may relinquish its resources. If there are no remaining emergency charging requests, then the device layer 602 may fully revert to non-emergency charging (which may be based on first-come-first-served, last-in-first served, etc.).

### 3.2 Aggregation Layer

Referring back to FIG. 6, the aggregation layer controls and coordinates multiple distributed energy resources (DERs) for e.g., utility platforms and/or energy markets. It collects, organizes, and orchestrates the behavior of multiple DERs, enabling them to act as a unified, grid-responsive asset. This layer may process real-time telemetry, enforce control policies across stakeholders, and/or translate grid signals into actionable commands for edge devices. The aggregation layer facilitates demand response, virtual power plant (VPP) operations, and multi-party control.

A variety of different approaches to aggregated control are possible. The aggregation layer may use a customer-driven “bottom-up” approach which collects requests from individual nodes to steer the behavior of the aggregate whole. Conversely, a business-driven “top-down” might start with the desired behavior of the aggregate and allocate to individual nodes toward that goal. Middle-out solutions might combine aspects of top-down and bottom-up, possibly with iterative refinements, etc.

Convoy is Kitu Systems' top-down, business-driven software implementation of an aggregation layer 604. Convoy aggregates and manages distributed energy resources (DERs) across multiple facilities, fleets, etc. focused on allowing a business to drive overall power toward business goals. Convoy enables multi-party access management and scalable fleet-wide optimization. It supports advanced features like coordinated dispatch logic-allowing multiple stakeholders (e.g., site operators, utilities, aggregators) to share control based on policy and/or priority.

Expedition CMS is Kitu Systems' bottom-up, customer-driven software implementation of an aggregation layer 604. Expedition CMS manages the operation of electric vehicle (EV) charging infrastructure for customer-friendly applications, such as public parking lots, etc. Expedition CMS provides user-friendly charge management capabilities, including charger access control, load scheduling, energy cost optimization, LCFS credit tracking, and integration with building energy systems. It supports both Level 2 and DC fast chargers from multiple manufacturers and communicates with DERs and upstream platforms using open standards such as OCPP, IEEE 2030.5, and OpenADR.

Aggregation layer 604 may be implemented as a software service running within cloud infrastructure. While the foregoing discussion describes a software implementation, hardware implementations and/or programmable logic implementations may be substituted with equal success.

As a brief aside, cloud services refer to software services that can be provided from remote data centers. Typically, datacenters include processing resources, a routing infrastructure, and network interfaces. The datacenter's processing resource subsystem may include its servers, storage, and scheduling/load balancing logic. The routing subsystem may be composed of switches and/or routers. The network interface may be a gateway that is in communication with the broader internet. The cloud service provides an application programming interface (API) that “virtualizes” the data center's resources into discrete units of server time, memory, space, etc. During operation, a client request services that cause the cloud service to instantiate e.g., an amount of compute time on a server within a memory footprint, which is used to handle the requested service.

The data center has a number of physical resources (e.g., servers, storage, etc.) that can be allocated to handle service requests. Here, a server refers to a computer system or software application that provides services, resources, or data to other computers, known as clients, over a network. In most modern cloud compute implementations, servers are distinct from storage—e.g., storage refers to a memory footprint that can be allocated to a service. Data center resources may refer to the type and/or number of processing cycles of a server, memory footprint of a disk, data of a network connection, etc. For example, a server may be defined with great specificity e.g., instruction set, processor speed, cores, cache size, pipeline length, etc. Alternatively, servers may be generalized to very gross parameters (e.g., a number of processing cycles, etc.). Similarly, storage may be requested at varying levels of specificity and/or generality (e.g., size, properties, performance (latency, throughput, error rates, etc.)). In some cases, bulk storage may be treated differently than on-chip cache (e.g., L1, L2, L3, etc.).

The routing subsystem connects servers to clients and/or other servers via an interconnected network of switches, routers, gateways, etc. A switch is a network device that connects devices within a single network, such as a LAN. It uses medium access control (MAC) addresses to forward data only to the intended recipient device within the network (Layer 2). A router is a network device that connects multiple networks together and directs data packets between them. Routers typically operate at the network layer (Layer 3).

Lastly, the network interface may specify and/or configure the gateway operation. A gateway is a network device that acts as a bridge between different networks, enabling communication and data transfer between them. Gateways are particularly important when the networks use different protocols or architectures. While routers direct traffic within and between networks, gateways translate between different network protocols or architectures-a router that provides protocol translation or other services beyond simple routing may also be considered a gateway.

Conceptually, cloud services access, reserve, and use physically remote computing resources (e.g., processing cycles, memory, data, applications, etc.) with different degrees of physical hardware and/or infrastructure management. Modern data centers handle many different cloud services from a myriad of different entities—it's not uncommon for data centers to have average utilizations north of 60% (which compares favorably to the average utilization (<1%) for dedicated servers infrastructures). Computational efficiencies are directly passed onto the cloud service as operational cost; in other words, cloud services are only charged for the resources that they request.

While the foregoing discussion describes a cloud-based software implementation, server-based software as well as hardware implementations and/or programmable logic implementations may be substituted with equal success.

The aggregation layer 604 may include a charger integration and control logic. The charger integration and control logic manages real-time operation, monitoring, and scheduling of EV charging equipment across commercial depots, fleets, and multi-tenant sites. It may interface with EVSEs using e.g., OCPP (Open Charge Point Protocol), enabling vendor-agnostic communication for control commands, status updates, fault reporting, and firmware management. This module may handle both reactive operations (e.g., fault clearing, availability status) and proactive strategies such as load balancing, smart queuing, and demand-limiting controls, ensuring that charging is aligned with site energy policies and grid constraints.

The aggregation layer 604 may include a load scheduling and energy optimization engine. The load scheduling and energy optimization module manages EV charging in order to minimize energy costs, avoid demand peaks, and align with grid or facility constraints. Scheduling algorithms and energy policies balance vehicle charging needs with site-level objectives such as demand charge avoidance, time-of-use rate optimization, and DER integration (e.g., solar or battery usage).

In some implementations, the load scheduling and energy optimization engine may dynamically shape loads through rule-based scheduling, priority queuing, and/or real-time adjustment of charging rates. Other considerations may include e.g. driver requirements, operational constraints, tariff structures, energy forecasts, and fleet behavior. Highly granular, adaptive scheduling requires accurate, real-time data and increased computational overhead. Conversely, simpler static policies reduce complexity but may underperform in dynamic environments. Different operators may have different strategies to achieve their operational sophistication, infrastructure capabilities, and financial goals.

The aggregation layer 604 may include a dispatch and control coordinator logic. The dispatch and control coordinator logic executes control actions across large fleets of distributed energy resources (DERs); this may include targeted execution as well as policy-driven tuning. The dispatch and control coordinator logic receives dispatch signals-originating from grid operators, demand response programs, or automated algorithms—and translates them into control commands that can be sent to individual DERs or groups of assets based on priority, location, or operational constraints in real-time.

The dispatch and control coordinator logic may obtain network topology from a grid model/topology engine to ensure commands are scoped to specific feeders, substations, or voltage zones (“grid-awareness”). The dispatch and control coordinator logic may rely on the aggregation layer to communicate with DER endpoints via standardized protocols (e.g., IEEE 2030.5, OpenADR).

Variants may use event-driven dispatch (e.g., during grid emergencies or peak events) and/or scheduled control (e.g., for time-of-use programs). The dispatch and control coordinator logic may additionally juggle conflicting control claims from multiple stakeholders based on a variety of system constraints.

Targeted commands can improve system efficiency and grid responsiveness but requires more complex computation, data synchronization, and real-time communication infrastructure. Some implementations may offload computation complexity by relying on e.g., distributed policy-driven logic at other layers.

The aggregation layer 604 may include an orchestration engine. The orchestration engine coordinates distributed energy resources (DERs), enabling them to operate as unified, grid-responsive systems. It processes real-time telemetry, policy inputs, and grid signals to generate actionable control decisions-such as load reduction, curtailment, or energy dispatch-across diverse devices like EV chargers, batteries, and solar inverters.

Virtual Facility is Kitu Systems' software implementation of an orchestration engine. The Virtual Facility aggregates and manages distributed energy resources (DERs) across multiple locations as if they were a single, unified asset. It operates by integrating real-time data from DERs-such as solar panels, batteries, EV chargers, and controllable loads—and applying intelligent control strategies to optimize their performance. Through this digital coordination, the Virtual Facility can respond dynamically to grid signals, market opportunities, or user-defined goals. The desired result is to maximize energy efficiency, reduce operational costs, enable participation in grid services or demand response programs, and enhance overall system reliability-all without requiring physical consolidation of the assets.

The aggregation layer 604 may include a billing and incentives engine. The billing and incentives engine handles the monetization, financial tracking, and regulatory crediting of EV charging operations across commercial fleets, depots, and host sites. It collects, calculates, and processes energy usage data from charging sessions to support billing models (e.g., per-kWh, time-based, subscription) and incentive programs such as Low Carbon Fuel Standard (LCFS) credits, utility rebates, or carbon offsets. The engine may integrate with session control data, charger telemetry, and external payment systems to generate invoices, track credit accrual, and support financial reporting or reimbursement workflows.

The aggregation layer 604 may include a device registry. The device registry is a database for tracking, organizing, and managing all DERs enrolled in the platform. Its stores and maintains metadata and operational status for each DER-including device type, capabilities, location, ownership, configuration, and real-time connectivity state. The registry may support flexible device grouping (e.g., by site, feeder, function) to enable policy-driven control and scalable dispatch. In one specific implementation, a schema-driven registry architecture is used to scale the database to suit operator needs.

In some variants, the device registry may additionally create/update digital “device twins” that reflect the current state of physical assets. For example, Kitu Systems' software implementation of digital device twins are virtual models of physical energy devices-such as inverters, batteries, HVAC units, and EV chargers-enabling accurate simulation, monitoring, and control of their real-world behavior. These twins operate by continuously syncing with live device data and applying device-specific performance models to predict responses under different conditions.

Digital twins may be used in a variety of different ways. For example, certain legacy infrastructure may not support certain types of behaviors. Digital twins may be used to explore the instruction space for combinations of instructions that would create behaviors that have no direct translation via existing hardware protocols. In other words, an unsupported desired behavior may be first modeled within the digital twin to empirically derive makeshift instructions that would achieve the desired behavior in the physical devices.

The aggregation layer 604 may include access management and session control layer. The access management and session control layers regulate who can initiate charging sessions, under what conditions, and with what level of priority or permissions. This layer ensures policy-compliant use of EV charging infrastructure. Specifically, this layer authenticates users or vehicles-via RFID, mobile apps, fleet credentials, or API integrations—and enforces site-specific rules such as user tiering, reservation windows, or time-based access restrictions. Some implementations may use role-based access control (RBAC) framework that integrates with charger-level protocols (e.g., OCPP) to manage session start, stop, duration, power limits, and user authorization in real time. In some variants, usage is logged for billing, reporting, and operational oversight.

The aggregation layer 604 may include a policy and access control logic. The policy and access control logic governs access control to distributed energy resources (DERs) (e.g., entity, conditional access, priority/restrictions, etc.) enabling secure and coordinated multi-party participation across utilities, fleet operators, aggregators, and site owners. It enforces role-based access control (RBAC) and interprets policy rules that define how control rights are granted, shared, or overridden. For example, the policy and access control logic may prioritize utility dispatch during grid emergencies, but otherwise grant site-level autonomy under normal conditions, etc.

In one specific implementation, the policy and access control logic includes a hierarchical rules engine that evaluates identity credentials, contextual parameters (e.g., grid status, device ownership), and program logic to make real-time decisions about control execution. It may integrate with authentication systems, device registries, and orchestration workflows to obtain user roles, permissions, and regulatory requirements. Complex dynamic control delegation and stakeholder coordination enhances functionality but may also increase policy complexity and the risk of conflicts or misconfigurations. In one such implementation, the policy and access control logic may use policy driven decisions that are auditable to provide traceable decision logic (which may be important for a diverse body of stakeholders).

As but one such example, the aggregation layer may allow shared control of DERs between utility providers 610 and/or 30 party services 614. As but one such example, a 3^{rd} party services 614 may install a rechargeable home battery system within a customer's house. The rechargeable home battery system may store electricity for the customer's use enabling limited energy independence, grid reliability, and reduced energy costs. The customer may own the home battery system, but purchase ongoing post-deployment software services, maintenance/warranty support, and secure connectivity from the 3^{rd} party services 614. The 3^{rd} party services 614 may additionally coordinate with the utility providers 610 to e.g., store excess energy when abundant and/or provide surplus when energy is needed. By aggregating multiple participating systems together, the 3rd party services 614 may provide virtual power plant (VPP) style functionality for the utility providers 610, while customer's retain ownership and may decide when (whether) to participate.

Other aspects of policy and access control are described within U.S. Pat. No. 11,994,834 entitled “SYSTEM AND METHOD FOR SHARED CONTROL OF DISTRIBUTED ENERGY RESOURCES” filed Jan. 10, 2022, which claims the benefit of priority under 35 U.S.C. § 119(e) of U.S. Provisional Patent Application No. 63/135,096, entitled “SYSTEM AND METHOD FOR SHARED CONTROL OF DISTRIBUTED ENERGY RESOURCES”, filed Jan. 8, 2021, the each of which is incorporated herein by reference in its entirety. Methods for facilitating control of a distributed energy resource are described that consolidate control events from a first plurality of control events and a second plurality of control events, which may be of different priority. Events corresponding to the consolidated control events are sent to the distributed energy resource, the events controlling one or more parameters of the distributed energy resource.

The aggregation layer 604 may include a monitoring and diagnostics system for the common authority. The monitoring and diagnostics system provides real-time visibility into the operational status, performance, and health of DERs (e.g., EV charging infrastructure, etc.). This module enables proactive maintenance, uptime assurance, and operational transparency. It continuously collects and analyzes telemetry data from EV chargers-such as availability, fault codes, charging status, and energy throughput—and to trigger alerts or notifications when issues arise. The system may support both live monitoring and historical diagnostics, allowing operators to identify recurring faults, perform root-cause analysis, and optimize infrastructure performance over time.

High-frequency, detailed diagnostics may improve issue detection and reduce downtime, but can increase data volume, processing load, and communications bandwidth-particularly in large-scale or bandwidth-constrained environments. Conversely, lower-frequency or event-based monitoring reduces load but may delay detection or resolution of subtle performance issues. Some implementations may use e.g., monitoring intervals, alert thresholds, etc. Streaming (continuous) data analytics may support real-time analytics for stable throughputs, with pipelining. Batched (discontinuous) data analytics may flexibly support a range of throughputs and/or processing loads; however, batched processing is typically at best effort (indeterminate scheduling).

The aggregation layer 604 may include a communication gateway. A communication gateway translates, routes, and secures communication between distributed energy resources (DERs), site controllers, and upstream systems like utilities or market operators. It supports a range of open protocols (e.g., IEEE 2030.5, CSIP, OpenADR, OCPP, etc.). The gateway normalizes incoming data, validates message formats, and converts control commands into protocol-specific formats for other endpoints (e.g., devices, services, etc.). It may also manage session persistence, retry logic, and end-to-end encryption to enable network resilience and security.

The communication gateway may ensure that interactions between the platform, EV chargers, and external systems are secure and authenticated. It provides encrypted, tamper-resistant communication channels-typically leveraging protocols such as TLS, HTTPS, and secure OCPP—while enforcing authentication mechanisms like digital certificates and role-based access control. This layer also manages secure API gateways for integration with third-party systems (e.g., utilities, fleet management software, payment processors), ensuring that data and control commands are protected from unauthorized access or manipulation.

Stronger cryptographic protocols and access control policies improve protection but can introduce latency, increase computational overhead on edge devices, and complicate provisioning workflows. Some implementations may allow operators to tailor security policies based on risk tolerance, regulatory requirements, and deployment scale.

### 3.3 Utility/Grid Layer

Functionally, the utility/grid layer 608 provides an interface to utilities, grid operators, or energy market platforms. Typically, the utility/grid layer 608 integrates with enterprise utility systems such as DERMS, SCADA, ADMS, and GIS. The utility/grid layer 608 also provides for decision-making and system-wide orchestration; it may translate grid conditions and planning objectives into actionable control strategies across the fleet of connected devices. In one specific implementation, the utility/grid layer 608 enables topology-aware monitoring, control, and coordination of DERs in alignment with grid stability, reliability, and regulatory goals. This layer may expose visibility into real-time DER telemetry and enable targeted control signals based on circuit-level constraints. In some variants, the utility/grid layer 608 may support demand response, frequency regulation, and/or emergency load-shedding programs.

Citadel is Kitu Systems' software implementation of utility/grid layer 608. Citadel provides grid operators and utilities with a platform to manage and dispatch distributed energy resources (DERs) across their networks. It enables real-time telemetry ingestion, grid modeling, and intelligent dispatch of DERs based on grid conditions, location, and program priorities.

The utility/grid layer 608 may be as a software service running within cloud infrastructure. While the foregoing discussion describes a software implementation, hardware implementations and/or programmable logic implementations may be substituted with equal success.

The utility/grid layer 608 may include a grid model/topology engine. The grid model/topology engine provides spatially accurate, circuit-aware intelligence that enables utilities and grid operators to dispatch and monitor distributed energy resources (DERs) in a way that aligns with the physical realities of the electrical grid. It maps DERs to specific grid assets—such as feeders, substations, transformers, and circuits-so that control decisions can be made with full awareness of location, phase, and electrical impact. The engine operates by ingesting data from utility GIS and ADMS systems and inferring a real-time digital model of the grid that can be overlaid on DER locations and statuses. The resulting map enables topology-aware dispatch, where control actions can be scoped not just by program or fleet group, but by grid segment—e.g., curtailing DERs only on a congested feeder or voltage-sensitive node.

More directly, there may be distinct differences between physical topology of the electrical grid and its DERs, and their logical topology. Physical topology may be dictated by a variety of practical and/or real-world limitations. For example, existing power infrastructure may be geographically constrained whereas some DERs are mobile (e.g., EVs, etc.). Different stakeholders may want to logically organize DERs in various ways; e.g., geography, application type, ownership, size of assets, etc. Mapping between physical and logical organizations may enable consistent translations across multiple stakeholders.

Model accuracy directly affects computational complexity; while highly detailed grid models improve targeting and system performance, they demand more frequent data synchronization, robust data validation, and computational resources for modeling and simulation. Some variants may scale model (growing and/or pruning) complexity to provide desired functionality, while avoiding unnecessary compute.

The utility/grid layer 608 may include a telemetry and state management logic. At this layer, the telemetry and state management module collects, processes, and maintains real-time and historical data on the operational status, performance, and availability of distributed energy resources (DERs) across the utility's service area. It ingests telemetry streams from lower layers (aggregation layer and device layers) to synthesize this data into a system-wide state model. The module may validate telemetry data, map the telemetry data to the network topology, and/or store it in time-series databases for analytics, compliance, and decision support.

The telemetry and state management module may provide real-time visibility for grid operators. In some variants, the module may provide alert mechanisms for anomalies, and historical data access for performance auditing and regulatory reporting (which may be important for multiple stakeholders). As previously noted, data fidelity and system scalability increase computational complexity; high-frequency telemetry enables precise control and faster diagnostics but increases bandwidth usage, storage demand, and processing complexity-especially in large-scale deployments. Some variants may support configurable telemetry profiles, edge filtering, and prioritization logic, enabling utilities to tailor data collection based on asset criticality, network conditions, and operational priorities.

The utility/grid layer 608 may include a security and identity management engine. The security and identity management module ensures that all communication, control actions, and data exchanges are secure, authenticated, and comply with industry cybersecurity standards. It enforces access control, authenticates devices and users, and protects system integrity through cryptographic measures (e.g., TLS encryption, X.509 certificate-based mutual authentication, role-based access control (RBAC), etc.). The module may include a secure identity registry that binds digital certificates to DERs, users, and third-party platforms (e.g., aggregators), and verifies each transaction or control request against defined permissions and trust levels. Some variants may also maintain audit logs for compliance, incident tracking, and accountability.

While stricter authentication policies and encryption protocols enhance protection, they can increase overhead, complicate onboarding, and impact performance in large-scale or latency-sensitive environments. Some implementations may use a modular, policy-configurable security framework that enables utilities to apply varying levels of security rigor depending on asset criticality, program requirements, and deployment scale to e.g., balance robust protection and agility.

The utility/grid layer 608 may additionally support operator “dashboards”. Dashboards widely vary in information presentation, etc. Generally, they render information for utility operators and program administrators, to monitor, analyze, and control fleets of distributed energy resources (DERs) in real time. Graphical user interfaces (GUIs) are often used to represent the live operational view of DER activity, including status indicators, control history, alerts, and grid-aligned visualizations (e.g., circuit maps, asset heatmaps, and event timelines). Command line interfaces are less common but may be used for pinpoint precision and power users.

Some variants may support web-based dashboards using secure APIs to pull data from backend services. A variety of widgets and charts may render system-wide oversight and drill-down diagnostics. Key functionalities may include initiating or scheduling dispatch events, filtering assets by location or status, and accessing compliance and performance reports.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A tower apparatus, comprising:
a power distribution unit configured to control a plurality of power modules;
a plurality of dispensers configured to enable a power delivery via at least one port;
where the power distribution unit is configured to map a first power module to a first port and a second power module to a second port during a normal charging mode; and
where the power distribution unit is configured to map both the first power module and the second power module to the first port during an emergency charging mode.

2. The tower apparatus of claim 1, where the first port enables a first connected node to control a first rate of power delivery from the first power module during the normal charging mode,
where the first port enables the first connected node to control the first rate of power delivery from the first power module and a second rate of power delivery from the second power module during the emergency charging mode.

3. The tower apparatus of claim 1, where the tower apparatus further comprises a processor, and a non-transitory computer-readable medium comprising instructions that, when executed by the processor, cause the tower apparatus to:
receive a first charging request from a first node connected to the first port;
receive a second charging request from a second node connected to the second port; and
select an operational mode from the normal charging mode and the emergency charging mode based on the first charging request and the second charging request.

4. The tower apparatus of claim 3, where the instructions further cause the tower apparatus to rank the first charging request and the second charging request based on an intra-fleet policy promulgated by a fleet authority.

5. The tower apparatus of claim 4, where the first charging request comprises a first severity and the second charging request comprises a second severity, and the first severity and the second severity are selected from a first set of severity values of the intra-fleet policy.

6. The tower apparatus of claim 5, where the instructions further cause the tower apparatus to assign a first priority to the first charging request and a second priority to the second charging request, and the first priority and the second priority are selected from a second set of priority values of the intra-fleet policy.

7. The tower apparatus of claim 6, where the instructions further cause the tower apparatus to calculate a first expropriation authority based on the first priority and the first severity and a second expropriation authority based on the second priority and the second severity.

8. The tower apparatus of claim 4, where the intra-fleet policy enables ranking on a real-time schedule.

9. A method, comprising:
receiving a plurality of charging requests from a plurality of nodes;
ranking the plurality of charging requests to determine a service order, based on an intra-fleet policy;
providing power via a plurality of power modules based on the service order; and
in response to receiving an extra-fleet condition update, adjusting the intra-fleet policy.

10. The method of claim 9, further comprising dividing the plurality of nodes into a first set of nodes and a second set of nodes and where the service order provides power to the first set of nodes before the second set of nodes.

11. The method of claim 10, further comprising stacking a first set of power modules to charge at least the first set of nodes.

12. The method of claim 11, further comprising 1:1 mapping a second set of power modules to at least one of the second set of nodes.

13. The method of claim 12, where adjusting the intra-fleet policy comprises assigning a first incidence level to the first set of power modules and a second incidence level to the second set of power modules.

14. The method of claim 13, where the first incidence level is 0% and the second incidence level is 100%.

15. A tower apparatus, comprising:
a power distribution unit configured to control a plurality of power modules;
a plurality of dispensers configured to enable a power delivery via a first port and a second port;
a processor; and
a non-transitory computer-readable medium comprising instructions that, when executed by the processor, cause the tower apparatus to:
receive a first emergency charging request from a first node connected to the first port;
service the first emergency charging request with at least a first power module and a second power module via the first port; and
in response to a relinquishment event, re-map the second power module to a second node connected to the second port.

16. The tower apparatus of claim 15, where the relinquishment event comprises the first node exceeding a threshold state of charge.

17. The tower apparatus of claim 16, where the second power module is remapped service a non-emergency charging request from the second node connected to the second port.

18. The tower apparatus of claim 15, where the relinquishment event comprises receipt of a second emergency charging request that is senior to the first emergency charging request.

19. The tower apparatus of claim 18, where the first power module and the second power module are remapped to service the second emergency charging request from the second node connected to the second port.

20. The tower apparatus of claim 15, where the first power module and the second power module service the first emergency charging request at a nominal power output, and the tower apparatus further services at least one non-emergency charging request via a third power module at a reduced power output.
